(19) United States
(12) Patent Application Publication
(10) Pub. No.: US 2006/0240772 A1
(43) Pub. Date: Oct. 26, 2006

(54) Locator device with sensor based power management

(76) Inventors: Danny Schoening, Plano, TX (US); David W. Carstens, Plano, TX (US)

Correspondence Address: CARSTENS & CAHOON, LLP, P O BOX 802334, DALLAS, TX, 75380, US

(21) Appl. No.: 11/264,544

(22) Filed: Nov. 1, 2005

Related U.S. Application Data
(60) Provisional application No. 60/623,935, filed on Nov. 1, 2004.

(51) Int. Cl. H04B 7/24

(52) U.S. Cl. 455/39

(57) ABSTRACT

By combining a signal generator with integrated sensors and the ability to accept external instructions, a unique system of active devices can efficiently improve the overall power management and improve the products overall performance. One example of this system would be to design a force sensor, a RC network, an EEPROM, and a receiver module into a portable electronic device. In this system the device might be originally designed to “wake up” once every hour and transmit data. In addition, the device could further be designed to “wake up” and only send data if the sensor (S) is in the high state. Further, the device could be designed to “wake up”, check the force sensors signal or logic position, then query for external signals which might instruct the device to: remain on indefinitely, change the frequency of the DC, or ignore the force sensor. This methodology would give the user the ability to customize not only the power management of the system but also the overall performance of the device

### CROSS-REFERENCE TO RELATED APPLICATION

This application claims the benefit of and priority to a U.S. Provisional Patent Application No. 60/623,935 filed Nov. 1, 2004, the technical disclosure of which is hereby incorporated herein by reference.

### BACKGROUND OF THE INVENTION

1. Technical Field

The present invention relates generally to a locator device that provides either a general or specific location of an object to a website. More specifically the invention relates to the system for managing the power supply of the devices to increase the length of time for useful transmission of location information.

2. Description of the Related Art

Knowing the location of a loved one or a valuable object is a concern for many people. Whether it is a teenage child out on a Friday night, an elderly parent, or a new pickup truck, people grow attached to their family and possessions. Knowing the location of the person or object provides peace of mind. Sometimes the object has merely a financial value rather than an emotional attachment. For example, an ATM machine or the money boxes within are tempting targets for thieves.

Global positioning systems are a useful way of knowing almost the precise location of any device on the planet. However, handheld units only show that information to the user, and the units do not transmit the information to a concerned party at a distance. Further, handheld GPS units are still rather bulky and are not attractive enough to be worn by a teenager. Also, the units tend to be easily recognized and could be removed quickly by a kidnapper or a thief. Of course, in an effort to shrink the size of a GPS unit would normally require that the battery powering the unit be shrunk as well.

Therefore, a need exists for an inexpensive and small GPS unit that can be coupled to a transmitter. Such a unit must also have a small battery and yet make the most of the power offered by that small battery.

### SUMMARY

One of the primary design criteria for portable electronics is battery life and the frequency of recharging. This disclosure describes unique methodologies for not only conserving energy, but also how integrated sensors and programmable logic techniques can further conserve energy and alter the portable electronics original programming.

Prior art for energy conservation can be described under the label of “duty cycle” or “pulse generator” power management. This technique commonly uses resistor and capacitor (RC) network 100 and potentially other circuitry to trigger a signal pulse at a predetermined frequency. For example, FIG. 1 illustrates how a source voltage 102 passed through a simple RC network 106 may pulse a high signal to Vo 104 once every one hundred seconds and therefore create a 1% duty cycle.

By combining this methodology with integrated sensors 110 and the ability to accept external instructions, a unique system of active devices can efficiently improve the overall power management and improve the products overall performance. One example of this system would be to design a force sensor 110, a RC network 106, an EEPROM, and a receiver module into a portable electronic device. In this system the device might be originally designed to “wake up” once every hour and transmit data. In addition, the device could further be designed to “wake up” and only send data if the sensor (S) is in the high state as shown in FIG. 2.

Further, the device could be designed to “wake up”, check the force sensors signal or logic position, then query for external signals which might instruct the device to: remain on indefinitely, change the frequency of the DC, ignore the force sensor, etc. This methodology would give the user the ability to customize not only the power management of the system but also the overall performance of the device.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a pulse generator;

FIG. 2 illustrates the circuit of FIG. 1 combined with a sensor;

FIG. 3 illustrates a force sensor, an RC network, an EEPROM, and a receiver module into a portable electronic device; and

FIG. 4 is a schematic showing a locator device communicating a position to a station for conveyance to a website.

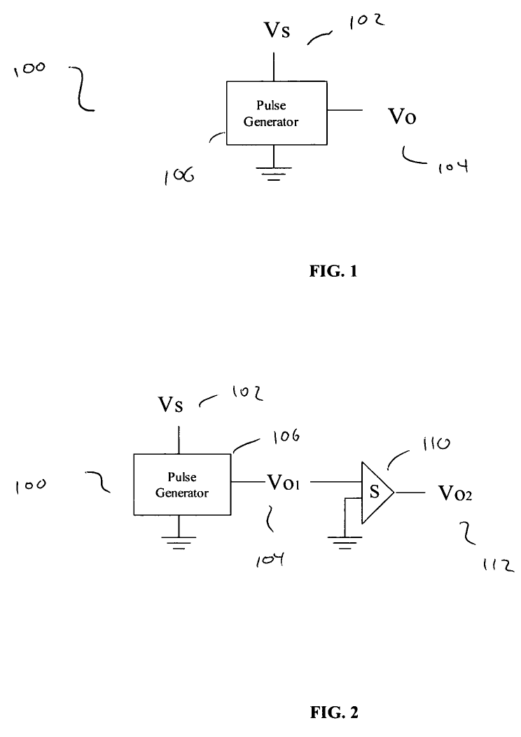

### DETAILED DESCRIPTION OF THE DRAWINGS

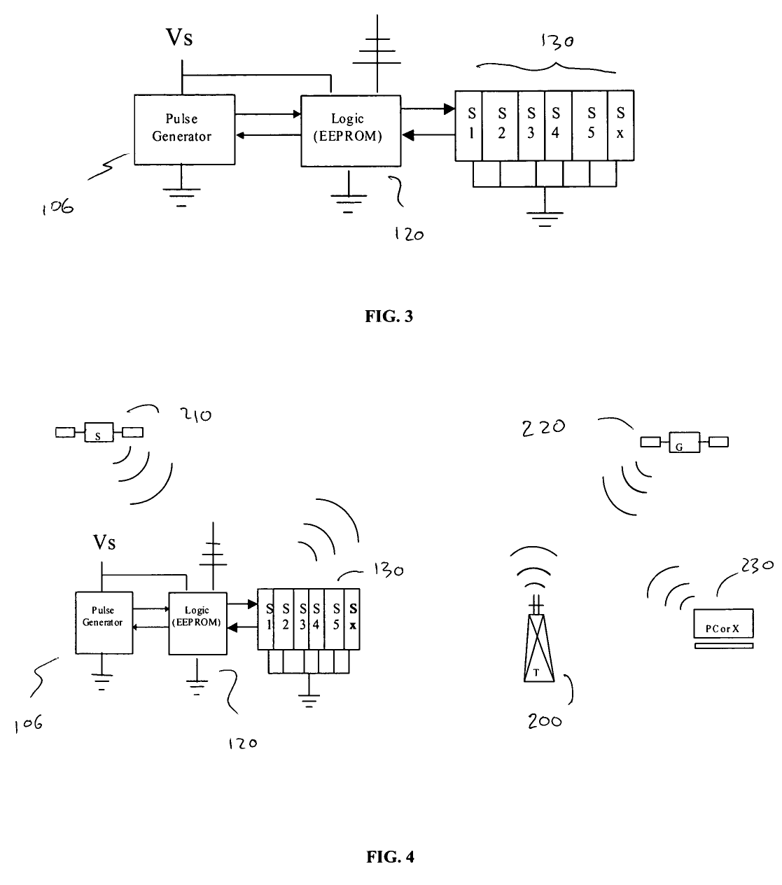

As discussed above, one example of this system would be to design a force sensor 110, a RC network 106, an EEPROM, and a receiver module into a portable electronic device. In this system the device might be originally designed to “wake up” once every hour and transmit data. In addition, the device could further be designed to “wake up” and only send data if the sensor (S) is in the high state as shown in FIG. 3.

Further, the device could be designed to “wake up”, check the force sensors signal or logic position, then query for external signals which might instruct the device to: remain on indefinitely, change the frequency of the DC, ignore the force sensor, etc. This methodology would give the user the ability to customize not only the power management of the system but also the overall performance of the device.

In another embodiment, this system could be used to extend the battery life of a locator device. For example, in FIG. 4, the device could be placed on a child or on a valuable item. The parent or owner could signal the device to check the conditions of multiple sensors 130 and based on the feedback, change the frequency of output. For example, a parent could use a cell phone or PC to send a signal 200 to the device that would change the output frequency from five minutes to one hour if a force sensor had not been activated (implying the device had not physically been moved).

Another example might be ATM or Cash Machine applications. The ATM owner might choose to use a high frequency output during the delivery of cash to the machine and then decrease the frequency once the cash box has been installed. In addition, the ATM owner might want to increase the frequency of output if the Sensors indicated loss of AC power, or an excessive tilt/force sensor output (indicating potential theft.) This remote information could be transmitted by (but not limited to): Cell Phones, Internet Protocol, Short Wave Transmitters, Long Wave Transmitters, Pagers, PDAs, etc.

Alternative systems might include (but are not limited to):
Sensors: Position, Temperature, Humidity, Global Position, Altitude, Pressure, Magnetic, Color, Shock, Air Flow, Liquid Displacement, Vibration, etc.
Logic: Partial Wake Up, Full Wake Up, Alter Existing Sensor Inputs, Change RC time cycles, Adaptive Learning from Previous Data, etc.
Devices: Cell Phones, Global Position Sensors, Pagers, Portable Computers, Blackberries (PDAs), Portable Bar Code Readers, On-Board Vehicle Devices, etc.
Electronics: Logic, Memory, EPROMs, EEPROMs, Flash Memory, R/C Networks, Integrated Circuits, Passive Devices, Active Devices, Internet Protocol, etc. FIG. 4 shows a potential integrated system.

Whereas S and G could represent communication and Global Positioning Satellites 210, 220, T represents ground communication towers, and a signal transmitter/receiver could be a Personal Computer, a PDA, a Cell Phone, etc.

The description of the present invention has been presented for purposes of illustration and description, but is not limited to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated

We claim:

1. A locator having a power management system comprising;
(a) a locator;
(b) a power management system coupled to the locator;
(c) at least one sensor to signal the power management system to obtain a location using the locator.

2. The locator of claim 1 further comprising:
(d) a transceiver coupled to the locator.

3. The locator of claim 1 wherein the locator comprises a GPS unit.

4. The locator of claim 1 wherein the power management system comprises at least one sensor.

5. The locator of claim 4 wherein the sensor is a G-force sensor.

6. The locator of claim 4 wherein the sensor is a position sensor

7. The locator of claim 4 wherein the sensor is a temperature sensor

8. The locator of claim 4 wherein the sensor is a magnetic sensor.

9. The locator of claim 4 wherein the sensor is a color sensor.

10. The locator of claim 4 wherein the sensor is an air flow sensor.

11. The locator of claim 4 wherein the sensor is a liquid displacement sensor.

12. The locator of claim 1 wherein the power management system further comprises a programmable logic device.

13. The locator of claim 12 wherein the logic device is an EEPROM.

14. The locator of claim 1 further comprises a receiver.

15. The locator of claim 1 further comprises a communications system for receiving a transmission of location data.

16. The locator of claim 15 further comprises a website interface for conveying the location data to an end user.
